(19) United States
(12) Patent Application Publication
(10) Pub. No.: US 2014/0237963 A1
(43) Pub. Date: Aug. 28, 2014

(54) APPARATUS FOR CENTRIFUGAL SEPARATION

(71) Applicants: Claes Inge, Saltsjo-Duvnas (SE); Peter Franzen, Huddinge (SE)

(72) Inventors: Claes Inge, Saltsjo-Duvnas (SE); Peter Franzen, Huddinge (SE)

(73) Assignee: 3NINE AB, 27 Nacka Strand (SE)

(21) Appl. No.: 14/343,868

(22) PCT Filed: Aug. 10, 2012
(86) PCT No.: PCT/EP2012/065675

§ 371 Date: Mar. 10, 2014

(30) Foreign Application Priority Data
Sep. 13, 2011 (SE) 1150826-4

(51) Int. Cl. B01D 45/14

(52) U.S. Cl. CPC B01D 45/14
USPC 55/443

(57) ABSTRACT

Rotor suspension device in a centrifugal separator (10) for cleaning a flow of gas from particles contained therein. The rotor (14) is rotatably supported in a cantilevered manner at one of its ends in a stationary casing (12) by means of a bearing sleeve (40) resiliently connected to the casing (12) by means of an elastic member (46) configured to counteract shearing and tilting movements of the supported end of the drive shaft (25) of the rotor during operation such that the free end of the rotor has a substantially fixed position relative to an upper passage (32) of the casing (12) through which the rotor top extends.

### CROSS-REFERENCE TO RELATED APPLICATION

This application is entitled to the benefit of and incorporations by reference subject matter disclosed in International Patent Application No. PCT/EP2012/065675 filed on Aug. 10, 2012 and from Swedish Patent Application No. 1150826-4 filed on Sep. 13, 2011.

### TECHNICAL FIELD

The invention relates to an apparatus for cleaning a flow of gas from solid and/or liquid particles therein by means of centrifugal separation, comprising a rotatable rotor in a surrounding, stationary casing and having a plurality of adjacent surface elements with an inner surface facing the center axis of the rotor onto which surface particles in said gas flow can be trapped by centrifugal forces during the radial passage of the gas flow between the surface elements, said surface elements of the rotor delimiting at least one axial flow shaft in the central portion of the rotor which communicates with the flow passages between the surface elements and with an opening in the rotor for the gas flow through a first wall of the casing, said casing delimiting a collection chamber for particles separated in the rotor and having an opening for the gas flow through a related wall of the casing and an outlet for the discharge of particles collected in the casing, said rotor having a first end extending through a first passage in said first wall, and a drive shaft extending through a second passage in a second wall opposite to said first wall of the casing, as well as a second end rotatably supported in a cantilevered manner and carrying a pulley on the outside of the casing.

### BACKGROUND OF THE INVENTION

In belt-driven centrifugal separators of this kind, wherein the rotor is supported in a cantilevered manner at one of its ends and is subjected to a force component normal to the rotor axis generated by the radial force onto the pulley below the rotor suspension, the other, free end of the rotor shaft, which extends through a passage of the stationary casing, is caused to move in the direction of the force by shearing action. Furthermore, the free rotor end makes a tilting motion such that the rotor axis no longer is upright. Such shearing and tilting motions of the top of the rotor are undesired, since this would necessitate a widening of the passage in the upper portion of the casing in order to avoid a collision between the free, rotating rotor end and the stationary casing. This will cause the gap between the rotor and the casing to be undesirably large, thereby resulting in a greater leakage of the gas flow from the inlet to the outlet in the casing.

### SUMMARY OF THE INVENTION

It is a primary object of the present invention to minimize the passage gap between the rotor and the casing during operation so that such a leakage will become as small as possible. This requires that the free end of the rotor does not perform any lateral movement when a radial force is exerted on the drive pulley at the bearing-supported end of the rotor.

For this purpose the apparatus set forth in the introduction is, according to the invention, characterized in that the drive shaft is supported in a surrounding, non-rotatable bearing sleeve which is resiliently connected to the stationary casing by means of at least one elastic member configured to counteract shearing and tilting movements of the supported end of the drive shaft during operation in such a manner that the first end of the rotor situated at the first passage has a substantially fixed position relative to the first passage. Thereby, the leakage gap between the rotor and the casing is minimized.

Preferably, the elastic member is configured as an annular, cylindrical spring element which simultaneously forms a sealing element between the bearing sleeve and the second wall of the stationary casing. This will minimize the number of components necessary for fixating the position of the free end of the rotor and to seal the other passage of the rotor.

In order to achieve said desired properties of the rotor suspension the cylindrical element is configured with the following conditions as to the stiffness of the member:

kₐ/kₛₜ=HᵣHₜ, where

kₐ is the tilting stiffness, kₛₜ the shearing stiffness, Hᵣ the axial distance between the point of action of the radial force F onto the pulley and the point of fixation of the cylindrical element to the bearing sleeve, and Hₜ is the axial distance between the fixation of the cylindrical element to the bearing sleeve and the end of the rotor at the first passage, and the elastic member is dimensioned according to the following condition:

4HᵣHₜ=3β(r_{y}²+rᵢ²), where

β is a geometrical constant of the cylindrical spring element, r_{y} the outer radius of the cylindrical element, and rᵢ the inner radius of the cylindrical element.

Preferably, the cylindrical element has the shape of an annular rubber element.

According to an optional embodiment of the apparatus of the invention a plurality of separate elastic members, such as rubber bodies or helical springs, are evenly distributed circumferentially about the bearing sleeve. In such cases there is a separate annular sealing element which closes the space between the bearing sleeve and the casing.

The bearing sleeve extends through the second passage in the second wall of the casing, while the elastic member joins the casing to a radial flange of the bearing sleeve. The radial flange is located either at an inwardly protruding end of the bearing sleeve or at an end thereof located outside the casing.

Alternately, the elastic member can join an axial, cylindrical portion of the bearing sleeve to an axial, cylindrical portion of the casing.

The apparatus of the invention can be configured to operate both in a co-current flow and a counter-current flow mode, in which cases the inlets and outlets of the various versions are reversed.

### BRIEF DESCRIPTION OF THE DRAWINGS

The present invention will be described more in detail below with reference to the accompanying drawings.

FIG. 1 illustrates schematically a first embodiment of a belt-driven centrifugal separator having a cantilevered, resilient suspension of the rotor according to the invention in a stand still condition;

FIG. 2 exaggeratedly illustrates the position of the rotor and its suspension relative to the casing of the separator during operation;

FIG. 3 illustrates another embodiment of an apparatus of the invention having six separate elastic suspension members;

FIG. 4 is a cross-section through the six elastic members in FIG. 3;

FIG. 5 illustrates an apparatus similar to that in FIG. 1 but with a reversed flow direction of the gas (co-current separation); and

FIGS. 6 and 7 illustrate schematically two optional locations of the elastic members.

### DETAILED DESCRIPTION

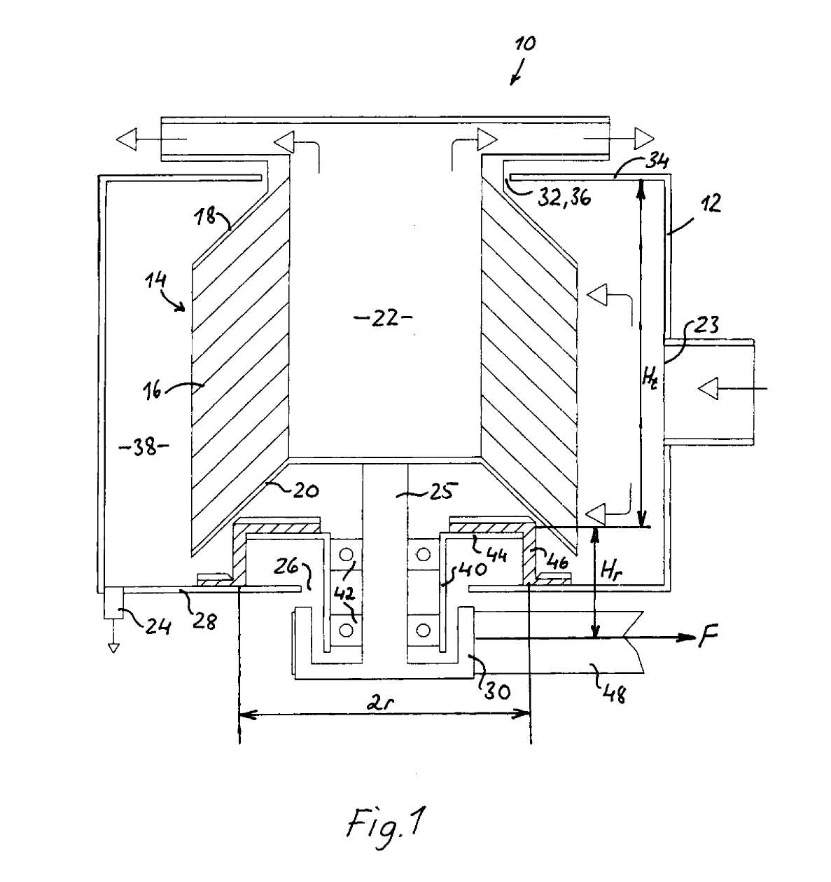

In FIG. 1 a belt-driven centrifugal separator of the invention for cleaning a gas flow from solid and/or liquid particles therein is generally denoted 10.

The separator 10 comprises a stationary casing 12 and a rotor 14 rotatably supported therein. The rotor 14 is, in a manner known per se, formed by a stack of a great number of conical surface elements 16 located at a small mutual axial distance to form narrow flow passages for the gas to be cleaned. The surface elements 16 are held together by an upper and a lower end plate 18 and 20, respectively, and delimit a central flow shaft 22, in the example shown an outlet shaft for the gas flow cleaned by counter-current separation through the rotor. The casing 12 has an inlet opening 23 for the gas to be cleaned, and an outlet 24 for separated particles. The rotor 14 has a drive shaft 25 extending through a passage 26 in a lower wall 28 of the casing 12 and carries a pulley 30 at its lower end. The upper end of the rotor 14 extends through a passage 32 in the upper wall 34 with the smallest gap 36 possible so as to minimize leakage from the collection chamber 38 to the environment. The rotor 14 is rotatably journalled in the casing only at the lower one of its ends, i.e. a cantilever suspension. The drive shaft 25 of the rotor 14 is here journalled in a surrounding, non-rotatable bearing sleeve 40 by means of two bearings 42. In the embodiment of FIG. 1 the bearing sleeve 40 extends through the passage 26 in the wall 28 and is, on an radially extending flange 44, resiliently attached to the inside of the lower wall 28 of the stationary casing 12 by means of annular elastic element 46 of e.g. a suitable rubber mixture.

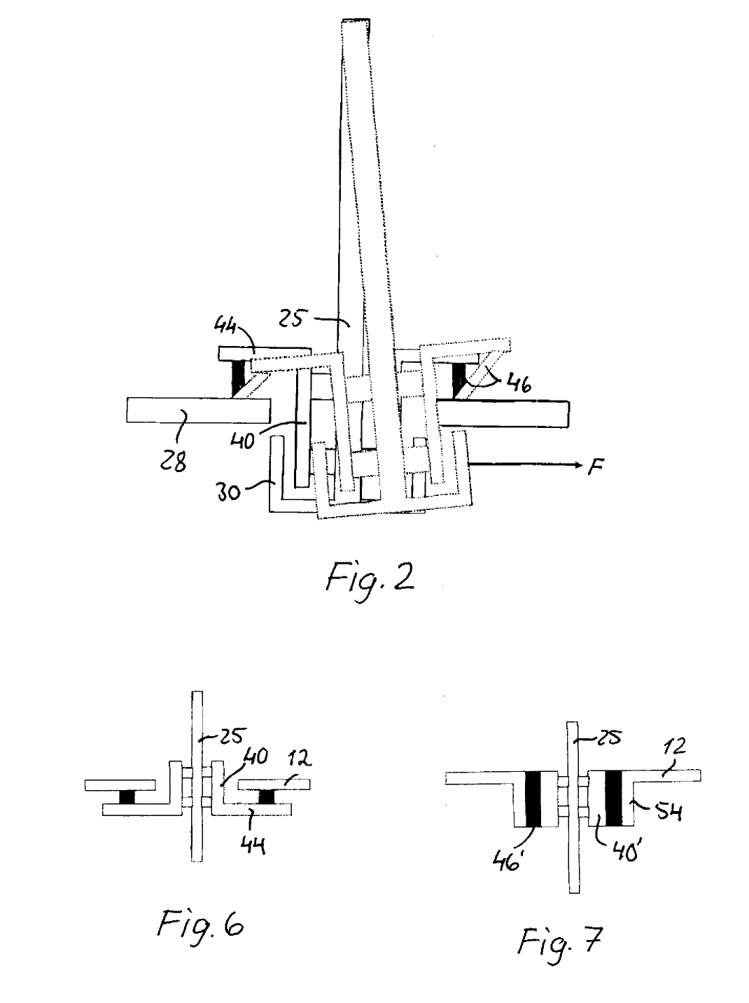

During operation of the apparatus, i.e. during rotation of the rotor 12, a drive belt 48 exerts a pulling force F on the pulley 30 and the rotor shaft 25. Due to this, the rotor shaft 25 normally tends to incline in such a manner through shearing and tilting that the lower end of the rotor is displaced to the right in FIG. 1, whereas its upper end is displaced somewhat linearly to the right, which means that the gap 36 between the top of the rotor and the passage 32 in the upper wall 34 of the casing 12 has to be larger to avoid collision of the rapidly rotating rotor 14 with the stationary casing 12. In avoiding such a collision by widening the gap 36 would on the other hand result in an undesired leakage of gas from the collection chamber 38 in the casing 12. Therefore, according to the invention, it is suggested to arrange the elastic member 46 between the bearing sleeve 40 and the casing 12 in such a manner that the upper end of the rotor 14 at the rotor passage 32 is substantially in a fixed position relative to the passage 32, as schematically and somewhat exaggeratedly shown in FIG. 2, i.e. such that the upper end of the rotor at the passage 32 is not displaced laterally during operation.

As shown in FIG. 1, the elastic member 46 is suitably configured as an annular cylindrical spring element, which may simultaneously form a sealing member between the bearing sleeve 40 and the lower wall 28 of the stationary casing 12, such that unclean gas in the collection chamber 38 is prevented from being discharged through the lower passage 26 in the casing wall 28.

In order to achieve the desired goal of having a rotor top not being moved laterally during operation following conditions as to the stiffness of the elastic member 46 are suggested:

kₐ/kₛₜ=HᵣHₜ, where

kₐ is the tilting stiffness, kₛₜ the shearing stiffness, Hᵣ is the axial distance between the point of action of the radial force F onto the pulley 30 and the point of fixation of the cylindrical spring element 46 to the bearing sleeve 40, and Hₜ is the axial distance between the fixation of the cylindrical spring element 46 to the bearing sleeve 40 and the passage, and the elastic member 46 is dimensioned according to the following condition:

4HᵣHₜ=3β(r_{y}²+rᵢ²), where

β is a geometrical constant of the cylindrical spring element 46, r_{y} the outer radius of the cylindrical element 46, and rᵢ the inner radius of the cylindrical element 46.

Instead of having a cylindrical, annular shape of the elastic member, a plurality of separate spring elements 50 may, in an optional embodiment of the apparatus of the invention shown in FIG. 3, be arranged evenly spaced circumferentially between the bearing sleeve 40 and the lower wall 28 of the casing. This is shown more clearly in the plan view of FIG. 4. In this case a separate sealing ring 52 is required so as to prevent leakage to the environment. Following condition should be fulfilled in this embodiment:

2HᵣHₜ/r²=kₖ/kₛ , where

Hᵣ is the axial distance between the point of action of the radial force F onto the pulley 30 and the point of fixation of the separate spring elements 50 to the bearing sleeve 40, Hₜ is the axial distance between the fixation of the elastic members 50 to the bearing sleeve 40 and the passage, r is the radius on which the individual elastic members are located, kₖ is the spring constant of the individual elastic members 50 in a compressed state, and kₛ is the spring constant of the individual elastic members 50 in a sheared state.

The separate spring elements 50 suitably consist of rubber but could also consist of helix springs (not shown).

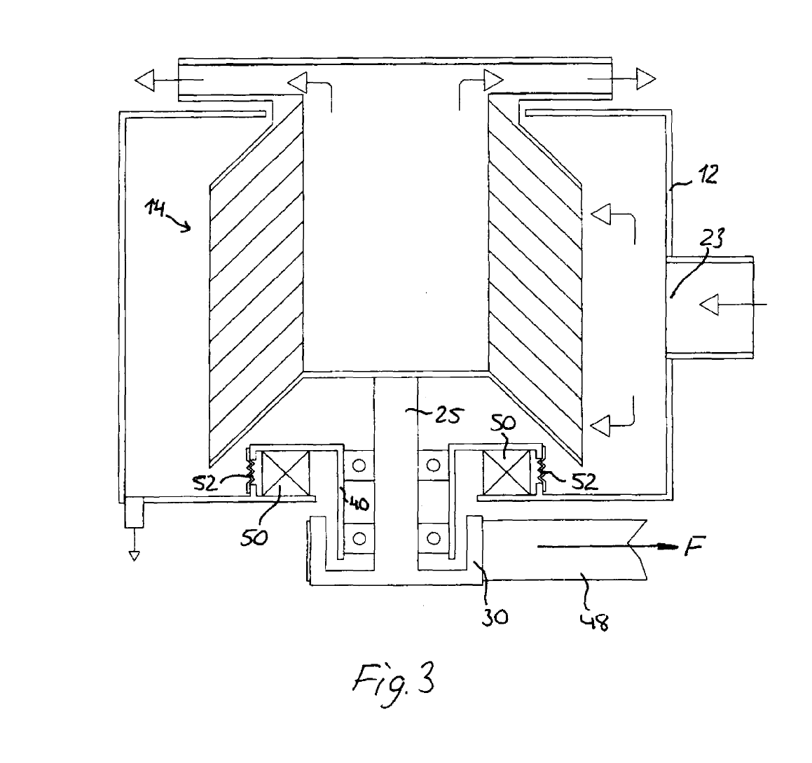

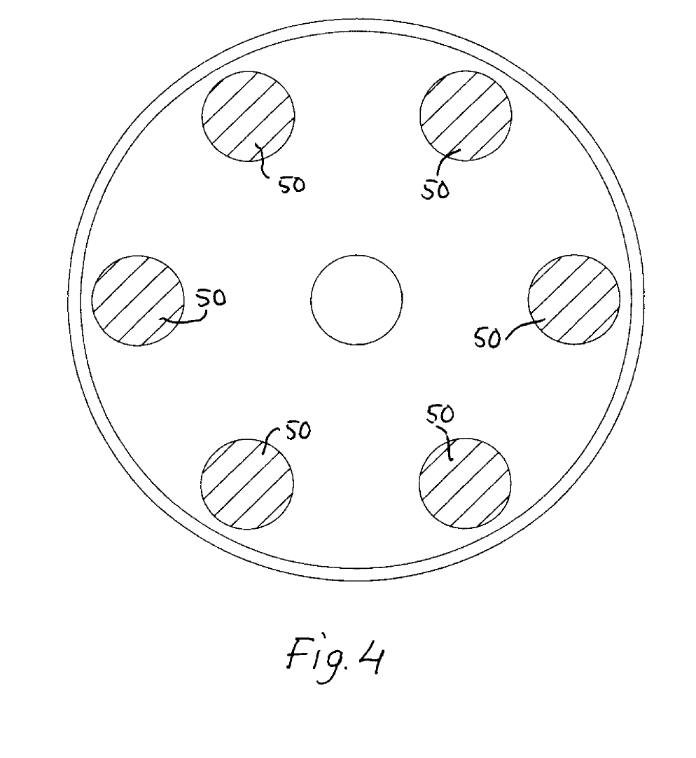

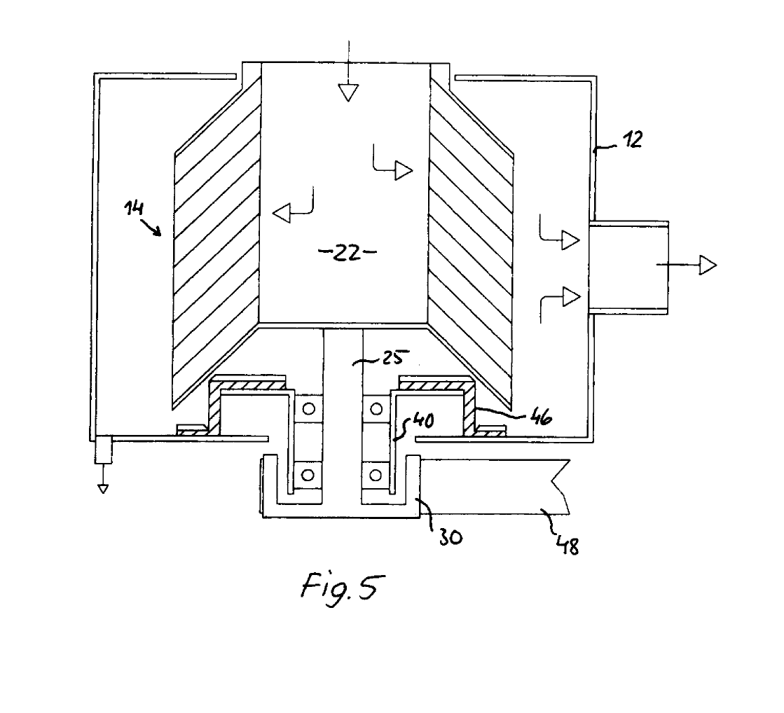

In the embodiment of FIG. 1 the radial flange 44 of the bearing sleeve 40 attached to the elastic member 46 is located on inside of the casing 12, whereas optionally the flange 44 is located on the outside of the casing 12, such as shown in FIG. 6. It is also conceivable, such as shown schematically in FIG. 7, that the bearing sleeve 40′ extends through the lower passage of the casing 12, in which case the elastic member 46′ connects an axial, cylindrical portion of the bearing sleeve 40′ to an axial, cylindrical portion 54 of the casing 12.

FIG. 5 illustrates an apparatus similar to that of FIG. 1, but here the flow of gas is reversed, i.e. the gas inlet and outlet are reversed, where the separator is operating in a co-current mode.

Although various embodiments of the present invention have been described and shown, the invention is not restricted thereto, but may also be embodied in other ways within the scope of the subject-matter defined in the following claims.

What is claimed is:

1. An apparatus for cleaning a flow of gas from solid and/or liquid particles therein by means of centrifugal separation, comprising a rotatable rotor in a surrounding, stationary casing and having a plurality of adjacent surface elements with an inner surface facing the center axis of the rotor onto which surface particles in said gas flow can be trapped by centrifugal forces during the radial passage of the gas flow between the surface elements, said surface elements of the rotor delimiting at least one axial flow shaft in the central portion of the rotor which communicates with the flow passages between the surface elements and with an opening in the rotor for the gas flow through a first wall of the casing, said casing delimiting a collection chamber for particles separated in the rotor and having an opening for the gas flow through a related wall of the casing and an outlet for the discharge of particles collected in the casing, said rotor having a first end extending through a first passage in said first wall, and a drive shaft extending through a second passage in a second wall opposite to said first wall of the casing, as well as a second end rotatably supported in a cantilevered manner and carrying a pulley on the outside of the casing, wherein the drive shaft is supported in a surrounding, non-rotatable bearing sleeve which is resiliently connected to the stationary casing by means of at least one elastic member configured to counteract shearing and tilting movements of the supported end of the drive shaft during operation in such a manner that the first end of the rotor situated at the first passage has a substantially fixed position relative to the first passage.

2. The apparatus according to claim 1, wherein the elastic member is configured as an annular cylindrical spring element which simultaneously forms a sealing element between the bearing sleeve and the second wall of the stationary casing.

3. The apparatus according to claim 2, wherein the cylindrical element is configured with the following conditions as to the stiffness of the member:
k_{α}/ kₛₜ=HᵣHₜ, where
k_{α} is the tilting stiffness, kₛₜ is the shearing stiffness, Hᵣ is the axial distance between the point of action of the radial force F onto the pulley and the point of fixation of the cylindrical spring element to the bearing sleeve, and Hₜ is the axial distance between the fixation of the cylindrical spring element to the bearing sleeve and the end of the rotor at the first passage, and the elastic member is dimensioned according to the following condition:
4HᵣHₜ=3β(r_{y}²+ᵢ²), where
β is a geometrical constant of the cylindrical spring element, r_{y} the outer radius of the cylindrical element, and rᵢ the inner radius of the cylindrical element.

4. The apparatus according to claim 2, wherein the cylindrical element has the shape of an annular rubber element.

5. The apparatus according to claim 1, wherein a plurality of separate elastic members are distributed circumferentially about the bearing sleeve.

6. The apparatus according to claim 5, wherein the following condition of the separate elastic members 2HᵣHₜ/r²=kₖ/kₛ, where Hᵣ is the axial distance between the point of action of the radial force F onto the pulley and the point of fixation of the separate elastic members to the bearing sleeve, Hₜ is the axial distance between the fixation of the elastic members to the bearing sleeve and the end of the rotor located at the first passage, r is the radius on which the individual elastic members are located, kₖ is the spring constant of the individual elastic members in a compressed state, and kₛ is the spring constant of the individual elastic members in a sheared state.

7. The apparatus according to claim 6, wherein the elastic members consist of rubber bodies.

8. The apparatus according to claim 6, wherein the elastic members consist of helix springs.

9. The apparatus according to claim 6, wherein at least one annular sealing element closes the gap between the bearing sleeve and the casing.

10. The apparatus according to claim 1, wherein the bearing sleeve extends through the second passage in the second wall of the casing, wherein the elastic member connects the casing to a radial flange of the bearing sleeve.

11. The apparatus according to claim 10, wherein the radial flange is located at an end of the bearing sleeve extending into the casing.

12. The apparatus according to claim 10, wherein the radial flange is located at an end of the bearing sleeve located outside of the casing.

13. The apparatus according to claim 1, wherein the bearing sleeve extends through the second passage in the second wall of the casing, wherein the elastic member connects an axial, cylindrical portion of the bearing sleeve to an axial, cylindrical portion of the casing.

14. The apparatus according to claim 1, wherein the opening of the rotor forms an outlet for a flow of gas cleaned in the apparatus, whereas the opening in the casing is an inlet for a flow of unclean gas into the casing.

15. The apparatus according to claim 1, wherein the opening of the rotor forms an inlet for a flow of unclean gas, whereas the opening of the casing is an outlet for a flow of gas cleaned in the apparatus.

16. The apparatus according to claim 3, wherein the cylindrical element has the shape of an annular rubber element.

17. The apparatus according to claim 7, wherein at least one annular sealing element closes the gap between the bearing sleeve and the casing.

18. The apparatus according to claim 8, wherein at least one annular sealing element closes the gap between the bearing sleeve and the casing.

19. The apparatus according to claim 2, wherein the bearing sleeve extends through the second passage in the second wall of the casing, wherein the elastic member connects the casing to a radial flange of the bearing sleeve.

20. The apparatus according to claim 3, wherein the bearing sleeve extends through the second passage in the second wall of the casing, wherein the elastic member connects the casing to a radial flange of the bearing sleeve.
